(19) United States
(12) Patent Application Publication
(10) Pub. No.: US 2019/0353563 A1
(43) Pub. Date: Nov. 21, 2019

(54) GENERATION PROGRAM, ABNORMALITY DETERMINATION APPARATUS, AND GENERATION METHOD

(71) Applicant: FUJITSU LIMITED, Kawasaki-shi (JP)

(72) Inventor: Takuya Nishino, Atsugi (JP)

(73) Assignee: FUJITSU LIMITED, Kawasaki-shi (JP)

(21) Appl. No.: 16/524,800

(22) Filed: Jul. 29, 2019

Related U.S. Application Data
(63) Continuation of application No. PCT/JP2017/004458, filed on Feb. 7, 2017.

(51) Int. Cl. G01M 99/00

(52) U.S. Cl. CPC G01M 99/005

(57) ABSTRACT

An apparatus for determining an abnormality includes: a memory; and a processor coupled to the memory, the processor being configured to execute setting processing that includes setting a determination region so as to exclude range of a frequency component of which waveforms of vibrations in a step before a change and a step after a change coincide each other in a predetermined error range, in a frequency spectrum for each step, the frequency spectrum being obtained from vibration data that is obtained by detecting, by a sensor, a vibration of a monitoring target apparatus executing a plurality of steps in a predetermined order using a rotary part, and execute generating processing that includes generating abnormality determination criterion information indicating a frequency region used to determine an abnormality of the monitoring target apparatus, in accordance with peaks of the frequency spectrum detected in the determination region.

### CROSS-REFERENCE TO RELATED APPLICATION

This application is a continuation application of International Application PCT/JP2017/004458 filed on Feb. 7, 2017 and designated the U.S., the entire contents of which are incorporated herein by reference.

### FIELD

The embodiment discussed to here is related to a generation program, an abnormality determination apparatus, and a generation method.

### BACKGROUND

A technique has been developed for measuring vibration of a monitoring target apparatus having a rotating rotary part such as a motor with a sensor and detecting an abnormality of the monitoring target apparatus from measured vibration data. The monitoring target apparatus may be, for example, an air conditioner, a semiconductor manufacturing apparatus, a vacuum pump, a centrifuge, or the like.

Examples of the related art include Japanese Laid-open Patent Publication No. 6-201452, Japanese Laid-open Patent Publication No. 6-221909, and Japanese Laid-open Patent Publication No. 2013-88431.

### SUMMARY

According to an aspect of the embodiments, an apparatus for determining an abnormality includes: a memory; and a processor coupled to the memory, the processor being configured to execute setting processing that includes setting a determination region so as to exclude range of a frequency component of which waveforms of vibrations in a step before a change and a step after a change coincide each other in a predetermined error range, in a frequency spectrum for each step, the frequency spectrum being obtained from vibration data that is obtained by detecting, by a sensor, a vibration of a monitoring target apparatus executing a plurality of steps in a predetermined order using a rotary part, and execute generating processing that includes generating abnormality determination criterion information indicating a frequency region used to determine an abnormality of the monitoring target apparatus, in accordance with peaks of the frequency spectrum detected in the determination region.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary abnormality detection system;

FIGS. 2A to 2C are diagrams illustrating extraction of feature amounts from vibration data;

FIG. 3 is a diagram illustrating changes of feature amounts when a plurality of steps are performed;

FIGS. 4A and 4B are diagrams illustrating detection of switching of a step and an abnormality using a feature amount;

FIG. 5 is a diagram illustrating a block configuration of an abnormality determination apparatus according to an embodiment;

FIGS. 6A and 6B are diagrams explaining a peak independent of rotation of a rotary part and a peak of a harmonic of a rotation frequency mixed in noise;

FIGS. 7A and 7B are diagrams illustrating accumulation of peak intensities and selection of peaks;

FIGS. 8A and 8B are diagrams illustrating a coherence spectrum and a cross spectrum;

FIG. 9 is a diagram illustrating an operation flow of determination region specification process for detecting an abnormality of a monitoring target apparatus according to the embodiment;

FIG. 10 is a diagram illustrating a rotation frequency of a rotary part according to the embodiment and a search for peaks of harmonics of the rotation frequency;

FIG. 11 is a diagram illustrating an operation flow of process for specifying rotation frequencies and harmonic peaks of the rotary part according to the embodiment;

FIG. 12 is a diagram illustrating an operation flow of generating processing of abnormality determination criterion information according to the embodiment;

FIG. 13 is a diagram illustrating abnormality determination criterion information according to the embodiment;

FIG. 14 is a diagram illustrating feature amount information;

FIG. 15 is a diagram illustrating an operation flow of abnormality detection process according to the embodiment;

FIG. 16 is a diagram illustrating another example of the abnormality determination criterion information according to the embodiment; and

FIG. 17 is a diagram illustrating a hardware configuration of a computer for realizing the abnormality determination apparatus according to the embodiment.

### DESCRIPTION OF EMBODIMENTS

However, for example, vibration may occur in a monitoring target apparatus due to a factor different from vibration caused by the rotation of the rotary part of an abnormality detect target. For example, in order to adjust a temperature of the monitoring target apparatus, piping through which a fluid passes may be provided in the monitoring target apparatus, and vibration may occur due to the fluid flowing through the piping. Further, such vibration which occurs due to factors other than the vibration caused by the rotation of the rotary part may lead to detection of an abnormality of the monitoring target apparatus to erroneous detection.

In one aspect, an object of the embodiment is to improve detection accuracy of an abnormality of a monitoring target apparatus.

Hereinafter, an embodiment will be described in detail with reference to the drawings. Same reference numerals are given to corresponding elements in a plurality of drawings.

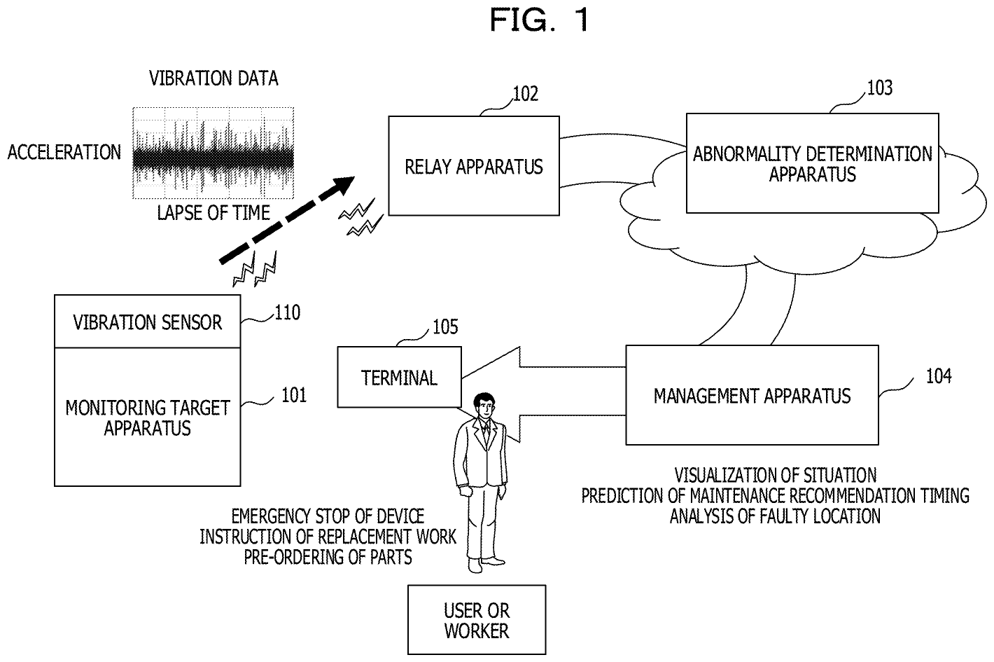

FIG. 1 is a diagram illustrating an exemplary abnormality detection system 100. The abnormality detection system 100 includes, for example, a monitoring target apparatus 101, a relay apparatus 102, an abnormality determination apparatus 103, a management apparatus 104, and a terminal 105. The monitoring target apparatus 101 may be, for example, an apparatus including rotary parts such as a motor, and may be an air conditioner, a semiconductor manufacturing device, a vacuum pump, a centrifuge, or the like. The monitoring target apparatus 101 may be provided with a sensor 110, such as an acceleration sensor and a displacement sensor, that detects vibration of the monitoring target apparatus 101. Then, the sensor 110 notifies the abnormality determination apparatus 103 of vibration data related to the detected vibration, for example, by wireless communication via the relay apparatus 102 such as a gateway. The sensor 110 may measure, for example, data on the vibration of the monitoring target apparatus 101 (hereinafter, may be referred to as vibration data). The vibration data may include, for example, a vibration component corresponding to the rotation speed (for example, revolution per minute (rpm)) of the rotary part and a vibration component of its harmonics.

The abnormality determination apparatus 103, for example, detects an abnormality of the monitoring target apparatus 101 based on the notified vibration data, and notifies the management apparatus 104 of the abnormality. The management apparatus 104 performs visualization of the situation, prediction of a time when maintenance of the monitoring target apparatus 101 is recommended, and analysis of a failure point, in response to the notification of the abnormality, by a manager or the like, for example. Then, according to the situation, an instruction is issued to the terminal 105 or the monitoring target apparatus 101 held by a user or a worker. The instruction may be, for example, an instruction for replacing parts, pre-ordering parts, and an emergency stop of the monitoring target apparatus 101. The user or worker may perform work such as replacement or order of parts according to the instruction notified to the terminal 105. In addition, the monitoring target apparatus 101 may perform an emergency stop, for example, upon receiving an emergency stop instruction.

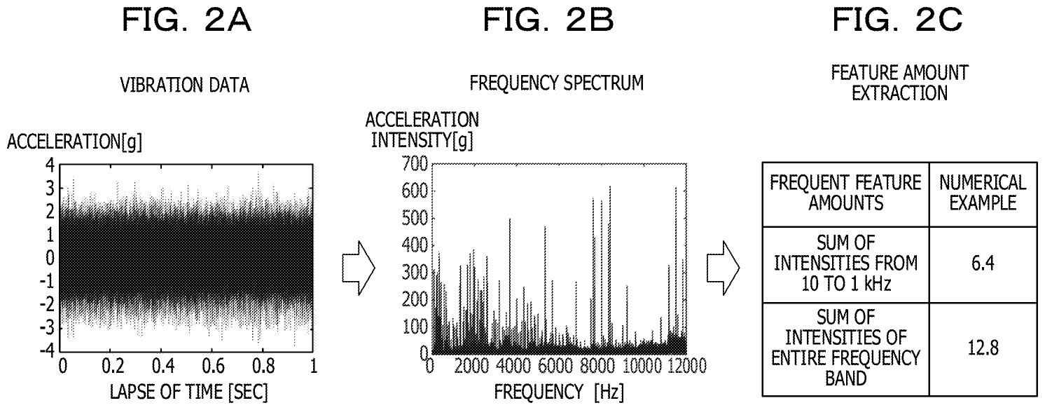

Moreover, since vibration data used for detection of an abnormality of the monitoring target apparatus 101 has a large amount of data, detection of an abnormality from the vibration data is executed, for example, by extracting feature amounts from a frequency spectrum obtained by transforming the vibration data by Fourier transform and using the extracted feature amounts. FIGS. 2A to 2C are diagrams illustrating extraction of feature amounts from vibration data. As illustrated in FIGS. 2A to 2C, for example, a frequency spectrum (FIG. 2B) is obtained by transforming vibration data (FIG. 2A) from the time region to the frequency region by Fourier transform. Then, for example, feature amounts may be obtained from the frequency spectrum by integrating intensities in a predetermined frequency range of the frequency spectrum. For example, FIG. 2C illustrates an example in which a sum of the intensities of the frequency spectrum from 1 kHz to 10 kHz obtained from the vibration data detected by the sensor 110 in the predetermined period and a sum of the intensities of all frequency bands are extracted as feature amounts.

The frequency range used for extracting the feature amounts may be set to an arbitrary range, and for example, the frequency range defined by the International Organization for Standardization (ISO) may be used to extract a feature amount. Then, for example, when the monitoring target apparatus 101 operates normally, a feature amount is acquired and learned, and a threshold value is set according to the learned feature amount. As a result, it is possible to determine that an abnormality has occurred in a case where a feature amount fluctuates beyond the threshold value during the operation of the monitoring target apparatus 101.

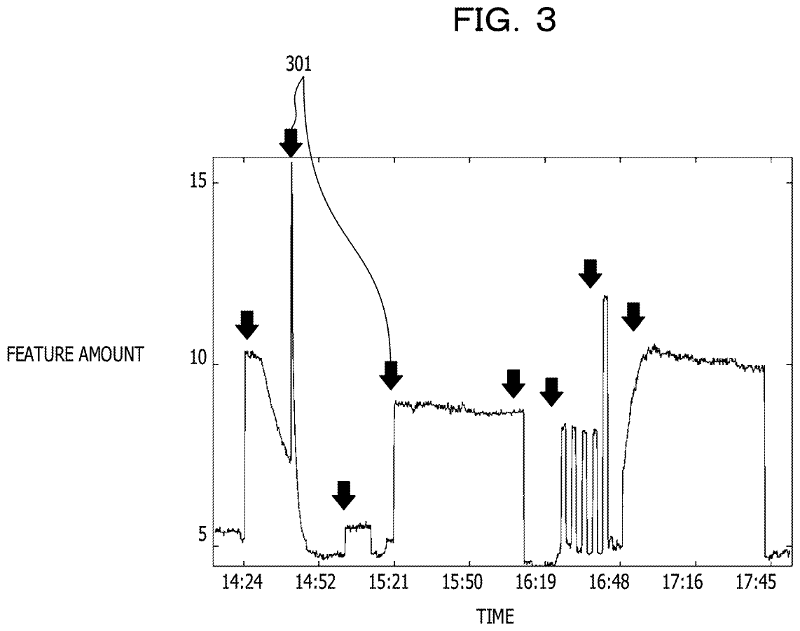

In addition, for example, the monitoring target apparatus 101 such as a semiconductor manufacturing device, may perform a plurality of steps by changing the operating conditions during operation. FIG. 3 is a diagram illustrating changes of feature amounts when a plurality of steps are performed. In FIG. 3, an arrow 301 indicates timing of switching the step, and as illustrated in FIG. 3, the feature amount fluctuates as the step is switched.

In such execution of a plurality of steps by the monitoring target apparatus 101, conditions of each step may change due to a production plan or the like, and for example, the time for executing each step varies. Therefore, there are situations in which it is difficult to set step switching timing in advance depending on time. However, in such execution of a plurality of steps by the monitoring target apparatus 101, the order of steps to be executed is fixed in many cases even though the time for executing the steps varies. Therefore, for example, by holding the order of the steps and the feature amount in each step, it is possible to detect switching of the steps or an abnormality of the monitoring target apparatus 101 from the change of the feature amount.

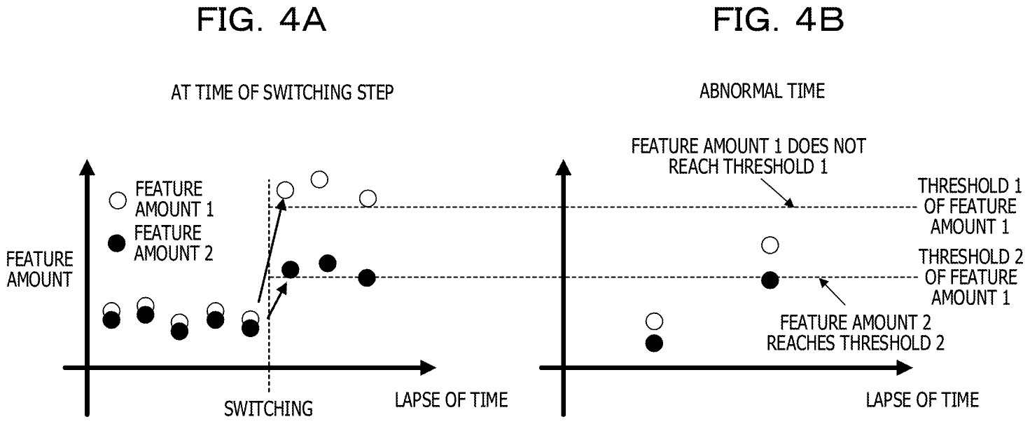

FIGS. 4A and 4B are diagrams illustrating detection of switching of a step and an abnormality using a feature amount. For example, vibration data is acquired from the sensor 110 in a state in which the monitoring target apparatus 101 operates normally, and a feature amount in a predetermined frequency region at the time of switching the step is learned from the frequency spectrum of the vibration data. A plurality of frequency ranges may be set and a plurality of feature amounts may be acquired. Then, a threshold is set based on the feature amount obtained by learning. For example, in FIG. 4A, two feature amounts of a feature amount 1 and a feature amount 2 are illustrated, and a threshold 1 and a threshold 2 are set for the feature amount 1 and the feature amount 2, respectively. Then, as illustrated in FIG. 4A, it is assumed that, for example, the vibration data which has illustrated a normal value of the feature amount before step switching deviates from the normal value of the step. Even in this case, if the deviated feature amount exceeds a threshold value and changes a normal value of the feature amount of a following step, it may be determined that the change of the vibration data is caused by the switching of the step. On the other hand, for example, in FIG. 4B, the feature amount 2 indicates a normal value of the feature amount of the following step, but the feature amount 1 is lower than the threshold 1 and deviates considerably from the normal value of the feature amount in the following step. Therefore, in FIG. 4B, it may be determined that there is an abnormality, not the switching of steps. In this way, it is possible to detect switching of a step or detect an abnormality of the monitoring target apparatus 101, by using the feature amount extracted from the vibration data.

However, for example, when a deposit or the like falls to the monitoring target apparatus 101 and an impact is applied thereto from the outside, a large vibration for a short time occurs, and a peak corresponding to vibration also appears in the frequency spectrum. Further, for example, when a signal intensity in an arbitrary predetermined frequency range is used as a feature amount in a situation where such an abnormal peak occurs, if an abnormal peak enters a region thereof, the feature amount may change to a value similar to the feature amount of the following step. Further, there is a possibility that it may be erroneously determined that the fluctuation is caused by switching to the following step and the state is normal, although an abnormality is generated. Therefore, for example, even in such a case, a technique capable of detecting an abnormality of the monitoring target apparatus 101 with high accuracy is desired. Then, in order to detect an abnormality of the monitoring target apparatus 101 with high accuracy, the inventor of the present application has developed the following method.

First, in a state where the monitoring target apparatus 101 that executes a plurality of steps in a predetermined order using rotary parts operates normally, the rotation frequency for each step from vibration data obtained by measuring vibration of the monitoring target apparatus 101 by a sensor and a peak position of the harmonics of the rotation frequency are specified. Then, based on the specified rotation frequency and the position and the intensity of the peak of the harmonic of the rotation frequency, a plurality of determination criterions are generated for each step. The plurality of determination criterions may be, for example, the presence or absence of peaks and the intensity of peaks in a plurality of frequency regions set around each of the rotation frequency in each step and the frequency of the harmonics of each of the rotation frequency.

Then, for example, it is assumed that the frequency spectrum of vibration data notified from the sensor includes peaks in a plurality of frequency regions set as a plurality of determination criterions corresponding to a certain step, and the peak intensities thereof are also within a predetermined error range from the peak intensity set as the determination criterions. In this case, it may be determined that a corresponding step is being performed.

Also, for example, thereafter, it is assumed that the frequency spectrum of the vibration data notified from the sensor does not include a peak in at least one frequency region of a plurality of frequency regions set as a plurality of determination criterions corresponding to the certain step. In this case, it is assumed that the frequency spectrum based on the vibration data from the sensor includes peaks in a plurality of frequency regions set as a plurality of determination criterions of the following step in a predetermined order, and the peak intensity is also within a predetermined error range from the peak intensity of the determination criterion of the following step. In this case, it may be determined that the monitoring target apparatus 101 has switched the step.

On the other hand, for example, in a case where the frequency spectrum based on the vibration data from the sensor does not include a peak in at least one frequency region of a plurality of frequency regions set as a plurality of determination criterions of the following step in a predetermined order, it may be that there is an abnormality. Therefore, for example, unlike the above-mentioned case where an abnormality is detected using feature amounts obtained from the same predetermined frequency region before and after a change point, the abnormality is determined based on the rotation frequency according to the step and the harmonic peak position of the rotation frequency, the abnormality may be detected with high accuracy.

Furthermore, in the frequency spectrum of the vibration data measured by the sensor, it is assumed that peaks exist in a plurality of frequency regions corresponding to the rotation frequency according to the step and each of the peaks of the harmonics of the rotation frequency. Also in this case, it is determined whether or not the peak intensities of the peaks present in the plurality of frequency regions have approximately the same magnitude as the peak intensities acquired when the monitoring target apparatus 101 operates normally. If the magnitudes of the peak intensities are different, it is that there is abnormality. Therefore, for example, even if an abnormal peak is generated by overlapping with the rotation frequency or the peak of the harmonic of the rotation frequency, the abnormal may be detected from the value of the peak intensity different from that at the normal time. Therefore, according to the method developed by the inventor of the present application, it is possible to detect an abnormality of the monitoring target apparatus 101 with high accuracy.

However, actually, in addition to the rotation frequency depending on the rotation of the rotary part and the peak of the harmonics of the rotation frequency, a peak which does not depend on the rotation of the rotary part is mixed in the waveform of vibration detected by the sensor 110. Further, the peak which does not depend on the rotation of the rotary part may cause an erroneous detection of an abnormality. For example, in a case where a peak independent of the rotation of the rotary part is picked up as a peak of a harmonic dependent on the rotation of the rotary part, it may be determined that there is an abnormality due to a difference in peak frequency, peak intensity or the like, between a peak of the original harmonic and a peak independent of the rotation of the rotary part. As a result, an abnormality may be erroneously detected.

Moreover, the peak of the harmonic may include a peak of a level mixed in the noise. In this case, since a ratio of the noise component to the peak of the actual harmonic is large, the position of the peak may be shifted, the variation of the intensity may be large, and an abnormality may be erroneously detected. Therefore, further improvement in the detection accuracy of the abnormality is desired.

In the embodiment described below, a frequency region including a peak independent of the rotation of a rotary part is specified, and the region is excluded to detect an abnormality. Therefore, it is possible to detect an abnormality without being influenced by the peak independent of the rotation of the rotary part.

Further, in the embodiment described below, a frequency region including a peak having a large peak intensity is extracted, and in the region, a feature amount related to the rotation frequency and a peak of the harmonic of the rotation frequency is acquired. Therefore, for example, it is possible to suppress erroneous determination of an abnormality by using the peak of the harmonic of the rotation frequency at a level mixed in the noise component for determination, and to improve the detection accuracy of the abnormality. The first embodiment will be described below.

### First Embodiment

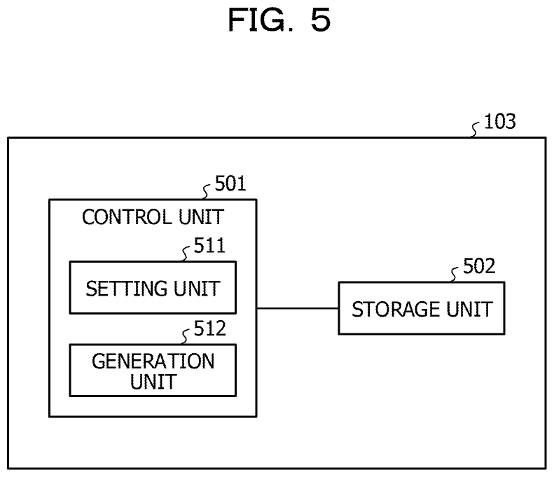

FIG. 5 is a diagram illustrating a block configuration of an abnormality determination apparatus 103 according to an embodiment. The abnormality determination apparatus 103 includes, for example, a control unit 501 and a storage unit 502. The control unit 501 operates as, for example, a setting unit 511 and a generation unit 512. The storage unit 502 stores, for example, information such as abnormality determination criterion information 1300 and feature amount information 1400 which will be described later. Details of these units and details of the information stored in the storage unit 502 will be described later.

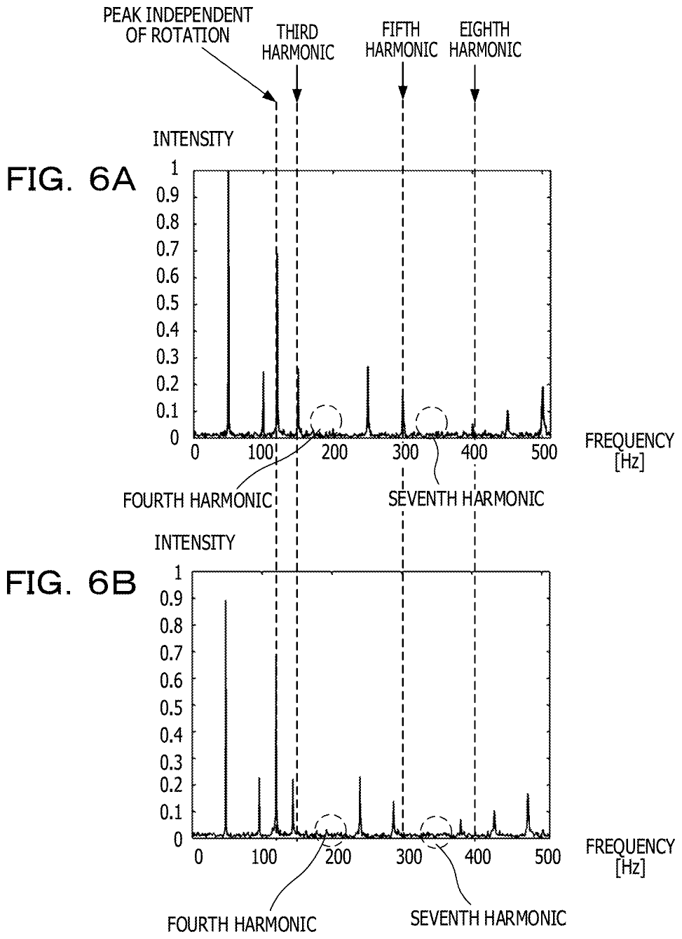

FIGS. 6A and 6B are diagrams explaining a peak independent of the rotation of a rotary part and a peak of a harmonic of a rotation frequency mixed in noise. FIG. 6A is a spectrum of vibration in step A, and FIG. 6B is a spectrum of vibration after transitioning from step A to step B. As illustrated in FIGS. 6A and 6B, the rotation frequency depending on the rotation of the rotary parts and the peaks of the harmonics of the rotation frequency (for example, a third harmonic, a fifth harmonic, and an eighth harmonic) are peaks of which positions are shifted, by fluctuations in the number of rotations due to changing of steps. On the other hand, there is a peak which does not depend on the rotation of the rotary part, and this peak is not shifted before and after the changing of the step. Note that, the peak independent of the rotation of the rotary part may be, for example, vibration generated due to a factor different from the rotation of the rotary part to be detected as an abnormality, and as an example, vibration caused by a fluid flowing through piping or the like, may be mentioned. For example, the monitoring target apparatus 101 may be provided with a pipe for passing a refrigerant for cooling the device, and vibration may occur when the refrigerant passes through the pipe. In this case, since the generated vibration is not caused by the rotation of the rotary part, the frequency component of vibration generated when the refrigerant is passing through the pipe does not change even if the rotation frequency of the rotary part shifts (fluctuates).

Here, self-excited vibration and forced vibration are known as classification of vibration. For example, according to a definition of Matsushita et al., vibration oscillating at a frequency specific to each machine is roughly classified into self-excited vibration. The self-excited vibration is natural vibration that occurs although the external force from outside is not applied all the time, vibrates at the natural frequency of each machine, and appears as a unique peak according to the size of a case, configuration of the machine, or the like, in a power spectrum. Further, since the self-excited vibration does not depend on the rotation speed of rotary parts, or the like, even if the rotation speed of rotary parts changes, the position of a peak does not change. As examples of self-excited vibration, a case where piping vibration, triggered by an external force generated temporarily such as an external force at the time of water passage to the water piping of the pump, a natural frequency is generated continuously, a case where vibration in the natural frequency, which depends on the conditions of a machine case, by the external force at the time of passage of air in semiconductor manufacturing equipment, is generated, and the like are mentioned.

On the other hand, forced vibration is vibration caused by a forced excitation force. For example, forced vibration indicates a frequency proportional to a force which is externally applied, such as rotation of a rotary part. Therefore, for example, the frequency of vibration changes due to the fluctuation of the rotational speed of the rotary part, and the excitation force and the response frequency coincide each other. For example, frequency components that change due to fluctuations in the rotation frequency of the rotary part accompanied with the step change of the monitoring target apparatus are roughly classified into forced vibrations.

Then, in the embodiment described below, for example, in order to accurately estimate the fluctuation of the forced vibration due to the change of the step in the presence of the self-excited vibration, a frequency region including the component of the self-excited vibration is specified.

[Region Specification of Self-Excited Vibration Component]

As described above, in the self-excited vibration, for example, even if the rotation frequency of the rotary part changes before and after the change of the step, the frequency of vibration does not change. Therefore, for example, at each frequency included in the power spectrum of vibration, it is assumed that the fluctuation of the waveform is checked before and after the change of the step. In this case, it is considered that the region where the fluctuation of the waveform falls within the predetermined error range includes the component of the self-excited vibration. Then, it is conceivable to use a coherence function γ²(f) as one method of checking the fluctuation degree of a waveform before and after the change of the step at each frequency included in the power spectrum of vibration. The coherence function γ²(f) is represented, for example, by the following Equation 1.

$${γ}^{2} ( f ) = \frac{{\vert {W}_{xy} \vert}^{2}}{{W}_{xx} * {W}_{yy}} \qquad ( 1 )$$

In Equation 1, f is a frequency of the target to be checked for waveform change. Wxx and Wyy are power spectra of vibration data x (t) of step X and vibration data y (t) of step Y, respectively. Wxy is a cross spectrum of vibration data x (t) of step X and vibration data y (t) of step Y.

The coherence function indicates, for example, the value 1 if vibration waveforms at the frequency f of the vibration data x (t) and the vibration data y (t) are completely coincident. On the other hand, the coherence function indicates, for example, value of 0 if there is completely no relationship in vibration waveforms at the frequency f of the vibration data x (t) and the vibration data y (t).

Further, cross spectrum Wxy(f) is represented by Equation 2, by representing Fourier transform of the vibration data x (t) and the vibration data y (t) as X(f) and Y(f), and a complex conjugate of X(f) as X*(f).

W_{xy}(f)=X̅*̅(̅f̅)̅Y̅(̅f̅)̅ (2)

The cross spectrum is the product of certain frequency components of spectra of two vibration data x (t) and vibration data y (t), multiplied and averaged. A large value represented at a certain frequency in the cross spectrum means that the frequency components of the two vibration data are highly correlated with each other at the frequency, and the magnitude of both components is also large.

As described above, since the self-excited vibration vibrates at an inherent frequency, it is estimated that the waveform of the vibration does not change before and after the change of the step. Therefore, if the value of the coherence function is approximately 1 at a certain frequency of the vibration data before and after the step change, it may be estimated that the peak at the frequency is the self-excited vibration peak. Therefore, the coherence function is calculated for each frequency included in the spectrum, and the frequency region indicating a value equal to or greater than a predetermined threshold value may be specified, whereby the region including the self-excited vibration peak may be specified. As the predetermined threshold value, a value that is represented to be statistically superior may be used, and for example, a value in the range of 0.95 to 1.0 may be used. In one example, the predetermined threshold may be 0.98.

Moreover, as described above, the peak of the harmonic may include a peak of a level mixed in noise. For example, in FIGS. 6A and 6B, the region where the fourth or seventh harmonic of the rotation frequency is located is mixed in noise and no peak is detected. In such a case, even if it is attempted to use the peak of the harmonic that is mixed in the noise to determine the abnormality of the monitoring target apparatus 101, the ratio of the noise component may be large and the abnormality may be erroneously detected. Therefore, in the embodiment described below, a high intensity peak is extracted from a plurality of peaks included in the spectrum. Since the high intensity peak has a high degree of contribution to the entire peak waveform, it is estimated that the amount of information regarding detection of the abnormality is also large.

[Specification of High Intensity Peaks]

As a method of extracting a high intensity peak from among a plurality of peaks included in the spectrum before and after the change of the step, using a cross spectrum is conceivable. As described above, the fact that a large value is represented at a certain frequency in the cross spectrum means that the frequency components of the two vibration data are highly correlated with each other at the frequency, and the magnitude of both components is also large. Therefore, in the cross spectrum, by extracting the peak with the highest peak intensity, it is possible to extract a relatively high intensity peak from among the plurality of peaks included in the spectrum before and after the step change.

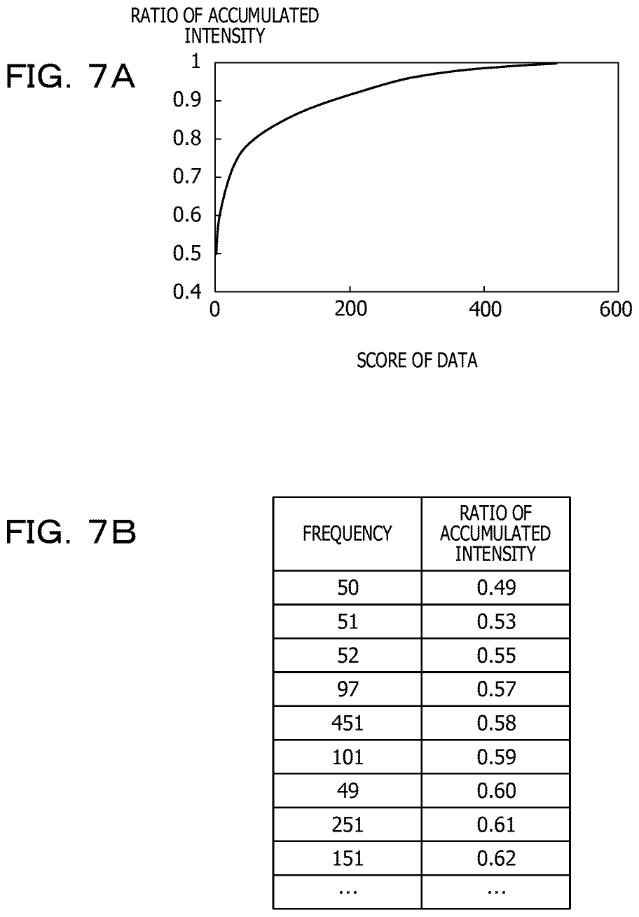

In the extraction of a peak having a high peak intensity, as one example, selecting the peaks in order from the highest peak intensity, accumulating the power of the selected peak (intensity sum), and carrying out the selecting until the proportion of accumulated value of power to entire power exceeds a predetermined threshold, are conceivable. FIGS. 7A and 7B are diagrams illustrating accumulation of peak intensities and selection of peaks. FIG. 7A is a graph illustrating a ratio of the accumulated value of the peak power accumulated in the descending order of peak intensities, to the power of the entire spectrum. As illustrated in FIG. 7A, it may be seen that only the peak with the large peak intensity has most of the power of the entire spectrum. FIG. 7B is a table illustrating the ratio of the accumulated value of the selected peak to the power of the entire spectrum. In FIG. 7B, the peak frequencies are arranged in order from the largest intensity, and the ratio of the accumulated value when the power of the peak is accumulated to the power of the entire spectrum is registered in association with the peak frequency. As a threshold of an accumulated intensity for selecting a peak, for example, a value of 60% to 90% may be used, and in one example, the value may be 70% or 80%. For example, when 60% is used as the threshold of the accumulated intensity, the peak of an upper stage from the frequency of 49 Hz in FIG. 7B is selected. For example, as described above, a peak with a high peak intensity may be selected from the cross spectrum. In another embodiment, a peak with a high peak intensity may be extracted by selecting a predetermined number of peaks including the peak with high intensity from the spectrum before and after the change of the step.

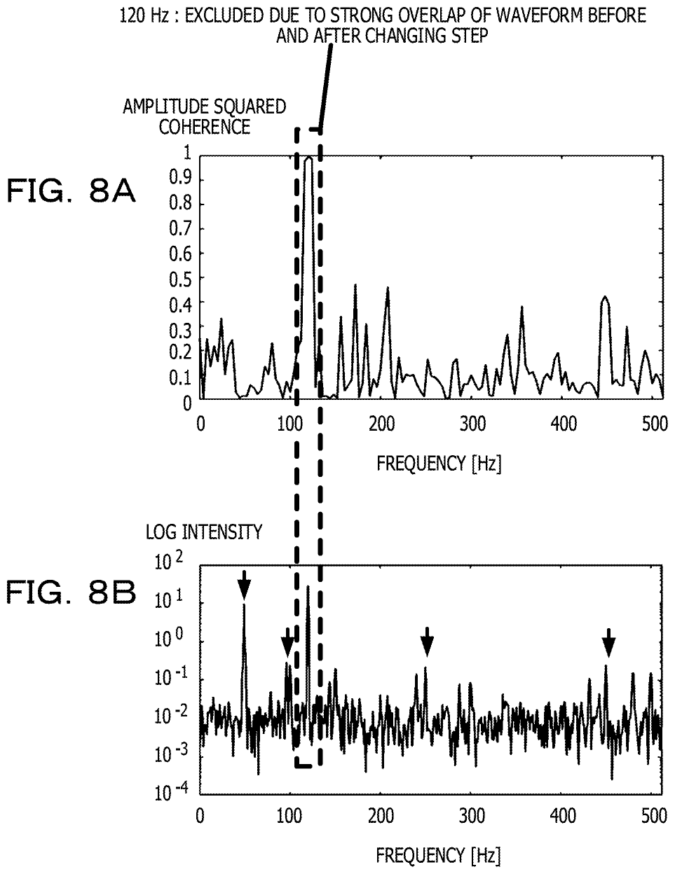

FIGS. 8A and 8B are diagrams illustrating a coherence spectrum and a cross spectrum. FIG. 8A illustrates the coherence spectrum. In FIG. 8A, near 120 Hz, a value of the coherence function indicates a value near 1. Therefore, in the coherence spectrum of FIG. 8A, it may be determined that the frequency region near 120 Hz where the value of the coherence function represents a value near 1 is a region including a peak based on self-excited vibration. In addition, it is estimated that the other frequency region does not include a peak based on self-excited vibration. Therefore, the control unit 501 sets the determination region excluding the frequency region near 120 Hz from the entire region of the spectrum.

Subsequently, the control unit 501 refers to the cross spectrum in FIG. 8B and selects a peak having a high peak intensity in the determination region (an arrow in FIG. 8B). The frequency region near 120 Hz has a high peak in the cross spectrum, however, the region is excluded from the determination region since it is considered as a component of the self-excited vibration, and, thus the peak in the frequency region near 120 Hz is not selected.

As described above, according to the embodiment, a peak having a high peak intensity is selected from the determination region excluding the frequency region in which the self-excited vibration is included. Therefore, the erroneous determination resulting from the peak of self-excited vibration may be suppressed. Further, a peak having a high peak intensity is extracted from the peaks of the forced vibration included in the determination region excluding the frequency region including the self-excited vibration, and is used for detecting an abnormality of the monitoring target apparatus 101. Therefore, it is possible to suppress erroneous detection of an abnormality by using a peak mixed in noise for determination of an abnormality detection. Therefore, according to the abnormality detection process according to the embodiment, it is possible to improve the detection accuracy of the abnormality.

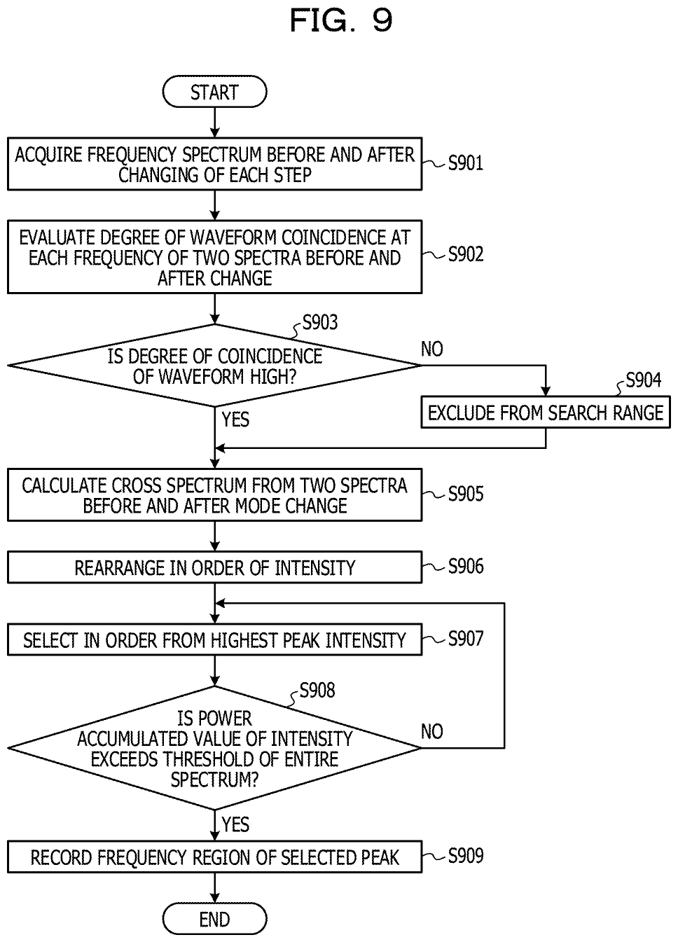

FIG. 9 is a diagram illustrating an operation flow of a determination region specification process for detecting an abnormality of the monitoring target apparatus 101 according to the embodiment, as described above. For example, the control unit 501 may start the operation flow of FIG. 9 when an instruction to execute the determination region specification process for detecting an abnormality of the monitoring target apparatus 101 is input. In the example of FIG. 9, it is assumed that vibration data at the time of execution of all of the plurality of steps have been acquired already from the sensor 110 at the start point of the operation flow in the state where the monitoring target apparatus 101 operates normally. Further, it is assumed that the change point which is switching timing of the step is also specified from the vibration data. The change point may be specified, for example, by monitoring the change of the feature amount using a sum of intensities of a predetermined frequency range of the frequency spectrum of vibration data as the feature amount.

In step 901 (hereinafter, the step is described as “S”, for example, S901), at each change point, the control unit 501 transforms each of the vibration data before the change point and the vibration data after the change point by Fourier transform, to obtain a frequency spectrum. The change point is, for example, a time point when a step is changed in a plurality of steps performed by the monitoring target apparatus 101.

In S902, the control unit 501 evaluates the degree of coincidence of the waveforms at each frequency included in the frequency spectrum before and after the change point of each step. For example, the control unit 501 may evaluate the degree of coincidence of the waveforms at each frequency, by calculating the coherence function γ²(f) of Equation 1 described above.

In S903, the control unit 501 determines whether the degree of coincidence of the waveforms is high for each of the frequencies included in the spectrum. For example, when the degree of coincidence of waveforms is evaluated by the coherence function, the control unit 501 may determine that the degree of coincidence of waveforms is high if γ²(f) of the coherence function is equal to or greater than a predetermined threshold, and in this case, the flow proceeds to S904. In S904, for example, the control unit 501 sets a determination region excluding the frequency region, which is determined in S903 to have a high degree of coincidence, from the entire frequency region of the spectrum. On the other hand, for example, when γ²(f) of the coherence function is less than a predetermined threshold, the control unit 501 may determine that the degree of coincidence of the waveform of the frequency component is low in the vibration data before and after the change of the step. In this case, the control unit 501 causes the flow to proceed to S905, including the determined frequency in which the degree of coincidence of the waveforms is low in the determination region. A determination region may set in which the region including the frequency component having a high degree of waveform coincidence is excluded, before and after the change of the step from the entire spectrum, by calculating each frequency included in the spectrum, at the processing of S903 to S904.

Subsequently, the control unit 501 executes processing of extracting a peak having a large peak intensity from the two spectra before and after the change of the step, in the determination region from which the region including the frequency component a high degree of waveform coincidence is excluded. As an example of a method of extracting a peak having a large peak intensity, using a cross spectrum is conceivable, and in the following S905 to S908, processing in the case of using the cross spectrum is illustrated. In S905, the control unit 501 calculates a cross spectrum of each of the two spectra before and after the change of the step. When the coherence function is used in S903, since the cross spectrum has already been calculated, the control unit 501 may use the cross spectrum of the calculation result.

In S906, the control unit 501 extracts peaks included in the determination region from the cross spectrum, and rearranges the extracted peaks in order of an intensity. In S907, the control unit 501 selects a peak from the larger peak intensity among the peaks included in the determination region. In S908, the control unit 501 accumulates the intensities of the selected peaks to calculate an accumulated intensity, and determines whether the ratio occupied by an accumulated value obtained by accumulating the selected peak intensities, respect to total cumulative value of the entire cross spectrum, exceeds a predetermined ratio. In a case where the cumulative value with respect to the total cumulative value does not exceed the predetermined ratio (NO in S908), the flow returns to S907 to select the next peak. On the other hand, in a case where the accumulated value with respect to the total cumulative value exceeds the predetermined ratio (YES in S908), the flow proceeds to S909. In S909, the control unit 501 resets the frequency region of the peak selected until the power accumulated value exceeds the predetermined ratio to the determination region and records the result in the storage unit 502, and the operation flow ends.

As described above, the control unit 501 excludes a frequency region including frequency components whose waveforms coincide each other within a predetermined error range, from the determination region, in the vibration data before and after the change of the step. A frequency component whose waveforms coincide each other within the predetermined error range is considered to be a vibration component caused by self-excited vibration, and it is estimated that the vibration is occurred independently of the rotation of a rotary part which is a monitoring target of an abnormality. Therefore, it is possible to detect an abnormality without being affected by the self-excited vibration, by excluding the region of the frequency components whose waveform coincide each other within the predetermined error range from the determination region.

Further, in the above-described operation flow, in the determination region excluding the component of the self-excited vibration, a frequency region including a peak having a higher peak intensity is extracted to further narrow the determination region. It is possible to estimate since, a peak with high peak intensity has significant data related to vibration. On the other hand, it is possible to suppress an erroneous determination of an abnormality due to a small level of peak mixed in noise, by extracting a frequency region including a peak having a high peak intensity.

### Second Embodiment

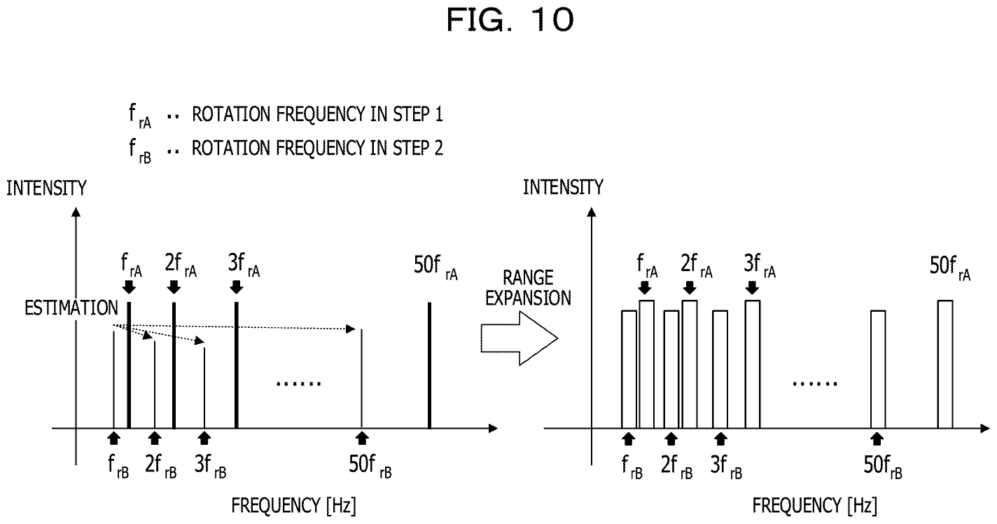

Next, with reference to FIGS. 10 to 16, a second embodiment will be described which illustrates the detection of an abnormality by using the determination region determined in the operation flow of FIG. 9 described above. In the second embodiment, regarding the determination region determined in the first embodiment, the control unit 501 specifies the rotation frequency of the rotary part and the peak of the harmonics of the rotation frequency, and sets the determination criterions for detecting an abnormality. Then, the control unit 501 detects an abnormality of the monitoring target apparatus 101 by using the determination criterions set for detecting an abnormality. First, with reference to FIGS. 10 to 14, processing of setting determination criterions for detecting an abnormality will be described.

FIG. 10 is a diagram illustrating a rotation frequency of a rotary part according to the embodiment and a search for peaks of harmonics of the rotation frequency. Hereinafter, the procedure of searching for the rotation frequency of the rotary part and the peak of the harmonic of the rotation frequency in each step performed by the control unit 501 will be illustrated.

(Procedure 1)

The control unit 501, for example, searches for and specifies the peak of the rotation frequency of each step from the frequency spectrum in each step of the vibration data measured by the sensor 110 (for example, f_{rA} of step 1 and f_{rB} of step 2 are specified in FIG. 10). For example, the control unit 501 may perform peak search from the low frequency side, and specify a peak of the rotation frequency by detecting a peak equal to or higher than a predetermined threshold.

(Procedure 2)

The control unit 501, for example, determines an initial search position of the peaks of the harmonic based on the rotation frequency corresponding to the detected step. For example, the control unit 501 estimates the peak position of the harmonic by multiplying the rotation frequency by an integer. Then, the control unit 501 determines, a peak position included in the determination region determined in the operation flow of FIG. 9 among the estimated peak positions of harmonics, as an initial search position for searching harmonics (see dashed arrow in FIG. 10).

(Procedure 3)

For example, the control unit 501 widens the frequency range from the initial search position within the determination region, determined in the operation flow of FIG. 9 described above, to acquire a sum of the intensities and specifies a position, where the inclination of the sum of changing intensities becomes a maximum value, as a peak position of the harmonic.

For example, the frequency range that broadens the search range may be set as follows. For example, the control unit 501 may set the search range corresponding to the peak of each harmonic according to the resolution of the frequency spectrum. For example, in a case where the rotation frequency specified in the above (1) is 100 Hz and resolution of the frequency spectrum is 1 Hz, actually, the rotation frequency: 100 Hz includes an error according to the resolution in the range of 99.5 Hz to 100.4 Hz. For example, in the case of a second harmonic, the error of this frequency falls within an error in a narrow frequency range from 199 Hz to 200.8 Hz, but in the case of a 50th harmonic, the frequency range is 4975 Hz to 5020 Hz, which is a wide range. Therefore, for example, the control unit 501 sets the frequency range obtained by multiplying the order of the harmonics by the error range corresponding to the resolution of the frequency spectrum, as the upper limit of the search range. Then, the control unit 501 may perform the search while expanding the search range to the range within the upper limit of the search range from the initial search position and within the determination region (FIG. 10). In the above example, for example, the upper limit of the search range may be set in the range of 199 Hz to 200.8 Hz in the case of the second harmonic, and 4975 Hz to 5020 Hz in the case of the 50th harmonic, which is in the range of 45 Hz, and the like.

As described above, the control unit 501 may specify the rotation frequency and the peaks of harmonics of the rotation frequency in the determination region.

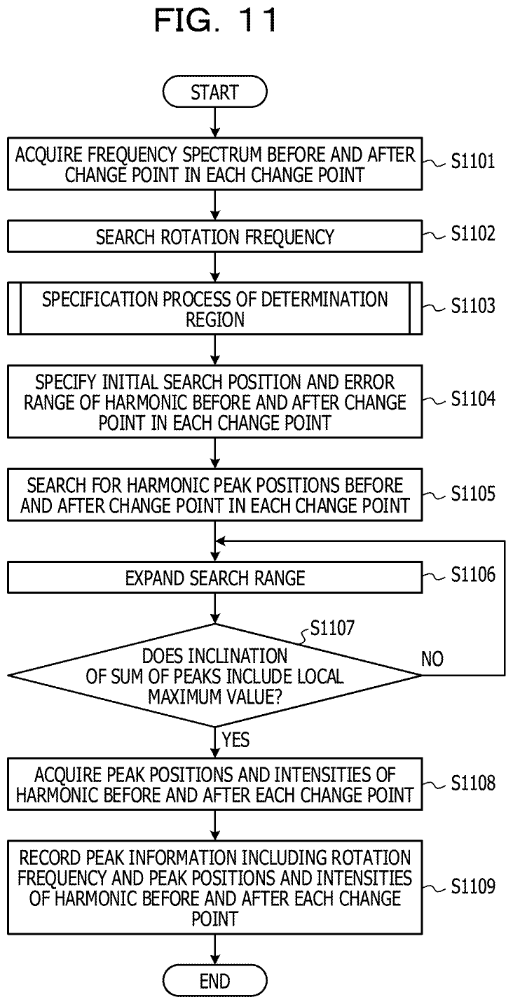

FIG. 11 is a diagram illustrating an operation flow of process for specifying rotation frequencies and harmonic peaks of the rotary part according to the embodiment. For example, the control unit 501 may start the operation flow of FIG. 11, when an execute instruction for a specific process is input from a user. In the example of FIG. 11, it is assumed that vibration data at the time of execution of all of the plurality of steps have been acquired already from the sensor 110 at the start point of the operation flow in a state where the monitoring target apparatus 101 operates normally. Further, it is assumed that the change point which is switching timing of the step is also specified from the vibration data. The change point may be specified, for example, by monitoring the change of the feature amount using a sum of intensities of a predetermined frequency range of the frequency spectrum of vibration data as the feature amount.

In S1101, the control unit 501 transforms each of the vibration data before and after the change point at each change point by the Fourier transform, to obtain a frequency spectrum.

In S1102, at each change point, the control unit 501 searches the frequency spectrum before and after the change point from the low-frequency side to specify the peak having a value larger than the predetermined threshold as a rotation frequency of the rotary part provided in the monitoring target apparatus 101.

In S1103, the control unit 501 executes determination region determination process. The control unit 501 may execute, for example, the operation flow of FIG. 9 in the determination region determination process. Further, in this case, since the spectra before and after the change point have been acquired in S1101, the control unit 501 may not execute the process of S901. As described above, the determination region specifying process specifies the determination region set in the frequency region excluding the component of the self-excited vibration and including the peak having a high peak intensity.

In S1104, the control unit 501 specifies the initial search position for searching for the peak of the harmonic of the rotation frequency and an error range indicating the upper limit and the lower limit of the search range for searching for the peak position, based on the rotation frequency specified in the frequency spectrum before and after the change point for each change point. For example, the control unit 501 estimates the peak position of the harmonic by multiplying the rotation frequency by an integer, and among the peak positions of the estimated harmonic, the peak position included in the determination region determined in the operation flow of FIG. 9 may be used as an initial search position for searching for harmonics.

Further, the control unit 501 may use a frequency range obtained by multiplying the order of harmonics by the error range based on the resolution of the frequency spectrum as the error range indicating the upper limit and the lower limit of the search range. For example, when the rotation frequency specified in S1102 is 100 Hz and the resolution of the frequency spectrum is 1 Hz, actually, there is a possibility that the rotation frequency 100 Hz may include an error in the range corresponding to the resolution, such as 99.5 Hz to 100.4 Hz. Then, for example, when the harmonic is the second harmonic, the control unit 501 may double this error range and set as an error range of upper limit for searching for the second harmonic peak in the range of 199 Hz to 200.8 Hz. For example, in the case of the 50th harmonic, an error range corresponding to the resolution such as 99.5 Hz to 100.4 Hz is multiplied by 50, and 4975 Hz to 5020 Hz may be set as the upper limit error range for searching for the peak of the 50th harmonic.

In S1105, in the frequency spectrum before and after the change point of each change point, the control unit 501 starts searching for the position of the peak of harmonic, setting a predetermined frequency region around the initial search position, including the initial search position set for each harmonic, as a search range. The predetermined frequency region may be, for example, a narrower range than the error range set in S1104.

In S1106, the control unit 501 extends the search range by a predetermined frequency. When the process of S1106 is first executed after the operation flow of FIG. 11 is started, the expansion of the frequency range in S1106 may not be performed. In addition, expansion of search range may be, for example, within the determination region determined in the operation flow of FIG. 9 described above, and the search range may expand gradually within the error range set in S1104.

In S1107, the control unit 501 obtains the intensity sum (integrated value) of the peaks in the expanded search range, and determines whether the slope of the intensity sum according to the expansion of the search range includes the maximum value. When the maximum value is not included in S1107 (NO in S1107), the flow returns to S1106, and the search range is expanded and the process is repeated. On the other hand, when the local maximum value is included at S1107 (YES in S1107), the flow proceeds to S1108.

In S1108, the control unit 501 specifies the position of the maximum value for each harmonic specified in S1106 before and after the change point as the peak position of the harmonic, for each change point, and acquire the wave peak intensity of the harmonics.

In S1108, for example, the control unit 501 records the peak information including the rotation frequency before and after the change point specified in S1102, the peak position before and after the change point of the peak of each harmonic specified in S1107, and the intensity thereof in the storage unit 502, and the operation flow ends.

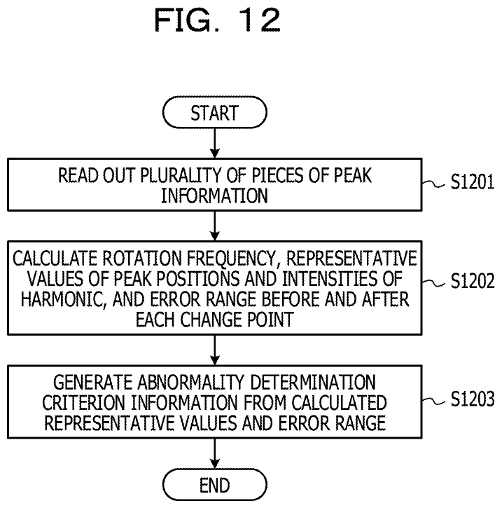

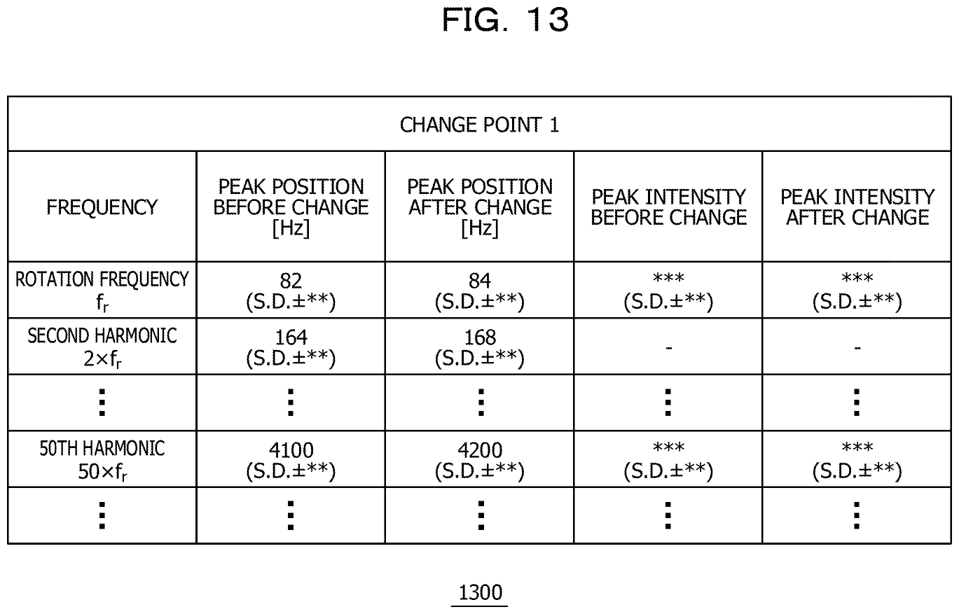

Subsequently, a processing of generating abnormality determination criterion information 1300 using peak information including peak positions before and after the change point of each peak of each harmonic and the intensity thereof recorded in the storage unit 502 in the operation flow of FIG. 11. FIG. 12 is a diagram illustrating an operation flow of generating processing of an abnormality determination criterion information 1300 according to the embodiment. For example, the control unit 501 may start the operation flow of FIG. 12 when an instruction to execute generating processing of the abnormality determination criterion information 1300 is input from a user. The details of the abnormality determination criterion information 1300 will be described later with reference to FIG. 13.

In S1201, the control unit 501 executes the operation flow of FIG. 11 a plurality of times for a plurality of steps performed in a predetermined order, and reads a plurality of past peak information recorded in the storage unit 502. In S1202, the control unit 501 calculates the representative value of the rotation frequency before and after each change point and the peak position of the harmonic and intensity thereof, and the error range of the representative value, from the rotation frequency before and after each change point and the peak position of the harmonic and intensity thereof included in each of the read peak information. For example, the control unit 501 may acquire the rotation frequency before and after the change point and the peak position of the harmonic and intensity thereof from each piece of peak information, calculates an average value for each of the peak position and the peak intensity to use the average value as a representative value. In addition, the standard deviation may be used as an error range of the representative values. The representative value is not limited to the average value, and may be, for example, other statistical values such as maximum value, minimum value, median value, and mode value. Further, the error range is also not limited to the standard deviation. For example, for each of the peak position and the peak intensity, a range from the maximum value to the minimum value for the step obtained from each piece of peak information may set as the error range.

In step S1203, the control unit 501 generates abnormality determination criterion information 1300 for each change point from the representative value of the rotation frequency before and after the change point calculated in S1202, the peak position and intensity of harmonics, and the error range thereof, and store the information in the storage unit 502. Then operation flow is ended.

FIG. 13 is a diagram illustrating abnormality determination criterion information 1300 according to the embodiment. The abnormality determination criterion information 1300 of FIG. 13 is, for example, abnormality determination criterion information 1300 for the change point 1 which is the first change point in a plurality of steps performed in a predetermined order. In the abnormality determination criterion information 1300, entries for rotation frequencies or harmonics detected in the determination region are registered. For example, the entry includes a peak position before the change point or after the change point and a peak intensity in association with the rotation frequency or the frequency of harmonic detected in the determination region. Further, the abnormality determination criterion information 1300 also includes information on the error range for the peak position and the peak intensity. As described in the operation flow of FIG. 9, the determination region is set to a region excluding the component of the self-excited vibration and to a frequency region including a peak having a high peak intensity. Vibration generated due to the rotation of the rotary part may change in peak intensity before and after the change of the step. For example, although it is a high peak in one spectrum, it may become a low peak in the other spectrum, and in this case, the region of the other low peak may not be extracted as a determination region. In this way, an entry having a value in only one side, of which information on the peak of a certain harmonic is included before the change but not after the change, may be registered in the abnormality determination criterion information 1300.

As described above, the control unit 501 may acquire, for example, the rotation frequency of each step performed in a predetermined order, the position of the peak of the harmonics of the rotation frequency and the intensity thereof in the determination region, and also may acquire the error range for the peak and the intensity.

Subsequently, abnormality detection process of the monitoring target apparatus 101 according to the embodiment will be described.

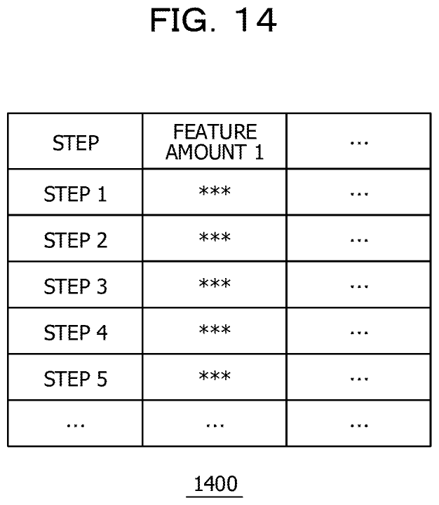

FIG. 14 is a diagram illustrating feature amount information 1400. In the feature amount information 1400, an entry including feature amounts corresponding to respective steps of a plurality of steps executed by the monitoring target apparatus 101 is registered. The entry may include one or more feature amounts. For example, as illustrated in FIG. 2C, a sum of intensities in a predetermined frequency region in the frequency spectrum obtained from the vibration data detected by the sensor 110 may be used as the feature amount. A frequency range used as the feature amount may be set to any range, and for example, a frequency range defined by the International Organization for Standardization may be used as a feature amount. Alternatively, in another embodiment, a frequency range used as the feature amount may set in a predetermined region not including the error range of the rotation frequency corresponding to the step specified by the abnormality determination criterion information 1300 and the error range of the frequency of the harmonics of the rotation frequency. This is because, for example, the number of rotations may be controlled by synthesizing the waveforms of harmonics using an inverter and generating a distorted wave, and when in synthesizing harmonics, the waveform of the synthesized harmonics appears as a huge peak in a frequency spectrum. For example, when the frequency range of the feature amount is set as described above, the peak based on the harmonics synthesized by an inverter or the like is not included in the feature amount. Therefore, it is possible to suppress that the change of the intensity sum due to the peak based on the abnormality is mixed in the peak based on the harmonic synthesized by using an inverter or the like.

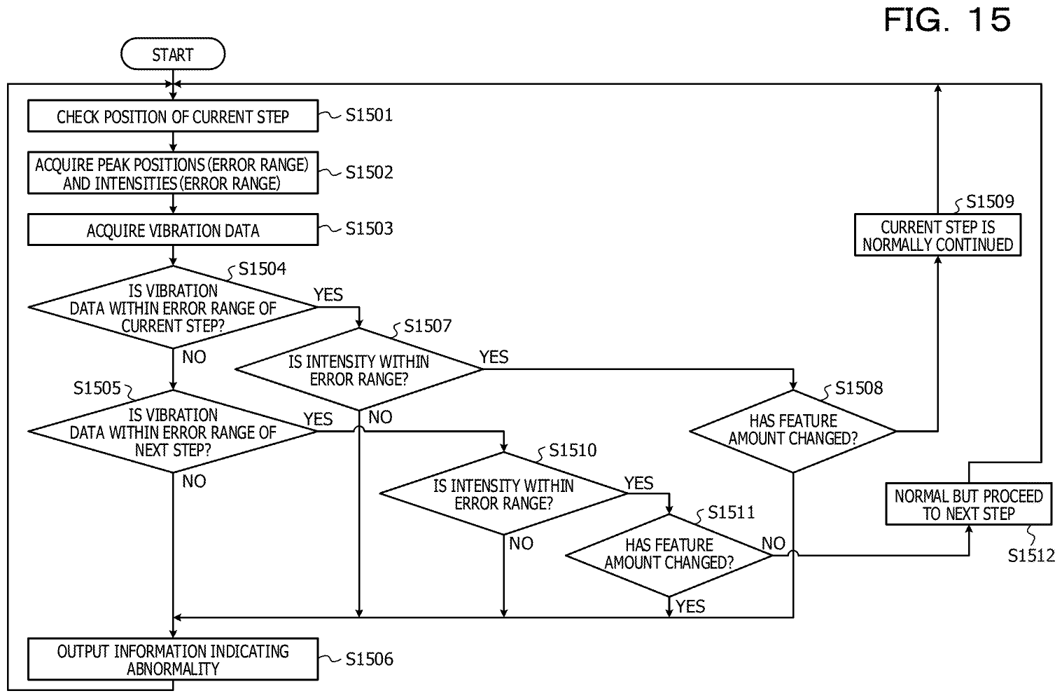

FIG. 15 is a diagram illustrating an operation flow of abnormality detection process according to the embodiment. For example, when an instruction to start detection of an abnormality of the monitoring target apparatus 101 is input, the control unit 501 of the abnormality determination apparatus 103 may start the abnormality detection process of FIG. 15.

In S1501, the control unit 501 confirms the position of the current step. For example, the storage unit 502 of the abnormality determination apparatus 103 may store step order information indicating the execution order of the plurality of steps executed by the monitoring target apparatus 101. In addition, the storage unit 502 may store step information indicating a step being executed, and the control unit 501 may update the step information to information indicating a shift destination step each time it is detected that the step executed by the monitoring target apparatus 101 has shifted to the next step. In S1501, the control unit 501 may check the position of the current step by referring to the step information stored in the storage unit 502. In the operation flow of FIG. 15, in a case where the processing of S1501 is executed for the first time, information indicating the step may not be recorded in the step information, and in this case, the control unit 501 may determine that the current step is a first step and may record the information indicating the first step in the step information.

In S1502, the control unit 501 acquires the rotation frequency in the next step after the change point and the current step before the change point and the position of peak of the harmonics of the rotation frequency and intensity thereof, from the abnormality determination criterion information 1300 corresponding to the change point from the current step to the next step, along with their respective error ranges.

In S1503, the control unit 501 acquires the latest vibration data from the sensor 110 provided in the monitoring target apparatus 101. In S1504, the control unit 501 determines whether or not the frequency spectrum of the acquired vibration data is within the error range of the rotation frequency or a plurality of peak positions corresponding to the harmonics of the rotation frequency for the current step acquired from the abnormality determination criterion information 1300. That is, in a case where the error range is the standard deviation, the control unit 501 determines whether or not the frequency spectrum of the vibration data includes a peak in the range of the standard deviation from the rotation frequency or the plurality of peak positions of the harmonics of the rotation frequency for the current step. In a case where the frequency spectrum of the acquired vibration data does not include a peak in at least one error range of the rotation frequency or the plurality of peak positions corresponding to the harmonics of the rotation frequency for the current step acquired from the abnormality determination criterion information 1300 (NO in S1504), the flow proceeds to S1505. In this case, the frequency spectrum illustrates that there is an abnormality as the frequency spectrum for the current step indicated in the step information.

In S1505, the control unit 501 determines whether or not the frequency spectrum of the acquired vibration data is within the error range of the rotation frequency or the plurality of peak positions corresponding to the harmonics of the rotation frequency for the next step acquired from the abnormality determination criterion information 1300. That is, in a case where the error range is the standard deviation, the control unit 501 determines whether or not the frequency spectrum of the vibration data includes a peak in a range of the standard deviation from the rotation frequency or the plurality of peak positions of the harmonics of the rotation frequency for the next step. In a case where the frequency spectrum of the acquired vibration data does not include a peak in at least one error range of the rotation frequency or the plurality of peak positions corresponding to the harmonics of the rotation frequency for the next step acquired from the abnormality determination criterion information 1300 (NO in S1505), the flow proceeds to S1506. In S1506, the control unit 501 outputs information indicating an abnormality, and the operation flow returns to S1501.

In addition, in S1504, in a case where the frequency spectrum of the vibration data includes a peak within the error range of the rotation frequency or the plurality of peak positions of the harmonics of the rotation frequency of the current step acquired from the abnormality determination criterion information 1300 (YES in S1504), the flow proceeds to S1507. In S1507, the control unit 501 determines whether or not the intensity of the peak of the frequency spectrum included in the error range of the plurality of peak positions for the current step is within the error range of the rotation frequency or the intensities of the harmonics of the rotation frequency of the current step of the abnormality determination criterion information 1300. In a case where the peak intensity of the frequency spectrum is not within the error range of the rotation frequency or the intensities of the harmonics of the rotation frequency of the current step of the abnormality determination criterion information 1300 (NO in S 1507), it is considered that the peak based on an abnormality overlaps with the peak corresponding to the rotation frequency or the harmonics of the rotation frequency of the current step. Therefore, the flow proceeds to S1506, and the control unit 501 outputs information indicating an abnormality. On the other hand, in a case where the intensity of the peak of the frequency spectrum is within the error range of the rotation frequency or the intensities of the harmonics of the rotation frequency of the current step (YES in S1507), the flow proceeds to S1508.

In S1508, the control unit 501 compares the feature amount corresponding to the current step acquired from the feature amount information 1400 with the feature amount obtained from the same frequency range of the frequency spectrum of the vibration data to determine whether or not the feature amount has changed beyond a predetermined error range. For example, by setting the frequency region for acquiring the feature amount to be used for determination to a region that does not include the rotation frequency and the peaks of the harmonics of the rotation frequency of the current step and registering the frequency region in the feature amount information 1400, it is possible to detect an abnormality without being affected by the harmonics synthesized by the inverter or the like. Then, in a case where the feature amount changes beyond the predetermined error range (YES in S1508), it is considered that a peak based on an abnormality is occurring in the region other than the rotation frequency or the peak positions of the harmonics of the rotation frequency of the current step. Therefore, the flow proceeds to S1506, and the control unit 501 outputs information indicating an abnormality. On the other hand, in a case where the feature amount has not changed beyond the predetermined error range (NO in S1508), the flow proceeds to S1509, it is determined that the current step is normally continued, and the flow returns to S1501.

In addition, in S1505, in a case where the frequency spectrum of the vibration data includes a peak within the error range of the rotation frequency or the plurality of peak positions of the harmonics of the rotation frequency of the next step acquired from the abnormality determination criterion information 1300 (YES in S1505), the flow proceeds to S1510. In S1510, the control unit 501 determines whether or not the intensity of the peak of the frequency spectrum included in the error range of the plurality of peak positions for the next step is within the error range of the rotation frequency or the intensities of the harmonics of the rotation frequency of the next step of the abnormality determination criterion information 1300. In a case where the peak intensity of the frequency spectrum is not within the error range of the rotation frequency or the intensities of the harmonics of the rotation frequency of the next step (NO in S1510), it is considered that the peak based on an abnormality is occurring, overlapping with the peak corresponding to the rotation frequency or the harmonics of the rotation frequency of the next step. Therefore, the flow proceeds to S1506, and the control unit 501 outputs information indicating an abnormality. On the other hand, in a case where the intensity of the peak of the frequency spectrum is within the error range of the rotation frequency or the intensities of the harmonics of the rotation frequency of the next step (YES in S1510), the flow proceeds to S1511.

In S1511, the control unit 501 compares the feature amount corresponding to the next step acquired from the feature amount information 1400 with the feature amount obtained from the same frequency range of the frequency spectrum of the vibration data to determine whether or not the feature amount changes beyond a predetermined error range. For example, by setting the frequency region for acquiring the feature amount to be used for determination to a region that does not include the rotation frequency and the peaks of the harmonics of the rotation frequency of the next step and registering the frequency region in the feature amount information 1400, it is possible to detect an abnormality without being affected by the harmonics synthesized by the inverter or the like. In a case where the feature amount changes beyond the predetermined error range (YES in S1511), it is considered that a peak based on an abnormality is occurring in the region other than the peak position of the rotation frequency or the harmonics of the rotation frequency of the next step. Therefore, the flow proceeds to S1506, and the control unit 501 outputs information indicating an abnormality. On the other hand, in a case where the feature amount does not fluctuate beyond the predetermined error range (NO in S1511), the flow proceeds to S1512. In S1512, the control unit 501 determines that the monitoring target apparatus 101 operates normally but shifts to the next step and updates the step information to information indicating the next step, and the flow returns to S1501.

As described above, according to the embodiment, the control unit 501 detects an abnormality based on a plurality of determination criterions for each step generated based on the rotation frequency of the rotary part and the harmonic frequencies of the rotation frequency of each step. As described in the operation flow of FIG. 9, the rotation frequency and the harmonics of the rotation frequency are searched in the region excluding the component of the self-excited vibration and in the determination region set in the frequency region including the peak with high peak intensity, and the determination criterions are set. Therefore, it is possible to suppress the erroneous determination of the abnormality caused by the self-excited vibration having a shallow relationship with the behavior of the rotary part.

Further, in the above-described operation flow, in the determination region excluding the component of the self-excited vibration, a frequency region including a peak having a higher peak intensity is extracted to further narrow the determination region. This is because it is estimated that the peak with high peak intensity has significant data on vibration. On the other hand, it is possible to suppress an erroneous determination of abnormality due to a small level of peak mixed in noise, by extracting a frequency region including a peak having a high peak intensity.

In the second embodiment, after the determination region is set in the operation flow of FIG. 9, a rotation frequency and a peak position of harmonic of the rotation frequency are searched in the determination region, abnormality determination criterion information 1300 is generated from the searched rotation frequency and the position and intensity of the peak of the harmonic of the rotation frequency, and a determination is performed. For example, compared to the case where a determination is performed using a feature amount obtained by setting a fixed arbitrary frequency region, the determination is performed based on the rotation frequency of the rotary part and the position and intensity of the peak of the harmonic of the rotation frequency. Because of this, it is possible to distinguish between switching of step and occurrence of an abnormality with high accuracy.

For example, the control unit 501 detects that the frequency spectrum of the vibration data from the sensor 110 includes a peak in the rotation frequency of the rotary part and the peripheral regions of the harmonic frequencies of the rotation frequency corresponding to the current step. In this case, the control unit 501 may determine that the current step is being continuously executed. Thereafter, in a case where a peak is no longer detected in either of the rotation frequency or the peripheral regions of the harmonic frequencies of the rotation frequency corresponding to the current step, whether a peak is included in the rotation frequency and the peripheral regions of the harmonic frequencies of the rotation frequency corresponding to the next step or not is determined. Then, for example, in a case where a peak is included in the rotation frequency and the peripheral regions of the harmonic frequencies of the rotation frequency of the next step, the control unit 501 may determine that the step is switched. On the other hand, in a case where a peak is not detected in at least one peripheral region of the rotation frequency and the peripheral regions of the harmonic frequencies of the rotation frequency corresponding to the next step, the control unit 501 may determine that an abnormality is occurred.

In addition, for example, in the above embodiment, in a case where the frequency spectrum of the vibration data includes a peak in the rotation frequency and the peripheral regions of the harmonic frequencies of the rotation frequency of the current step, subsequently, the control unit 501 compares the peak intensities to determine whether or not the peak intensity falls within the error range of normal peak intensities. In a case where the peak intensity deviates by a predetermined error range from the peak intensity at the normal rotation frequency and the harmonic frequencies of the rotation frequency, it is considered that an abnormal peak is occurring, overlapping with the rotation frequency or the peaks of the harmonic frequencies of the rotation frequency of the current step. Therefore, the control unit 501 may determine that there is an abnormality, also in this case.

In addition, in the above-described embodiment, in a case where the frequency spectrum of the vibration data includes a peak in the rotation frequency and the peripheral range of the harmonic frequencies of the rotation frequency of the next step, next, the peak intensities are compared and it is determined whether the peak intensity falls within the error range of the normal peak intensities of the next step. Therefore, it is possible to quickly detect the occurred abnormality at the same time as switching to the next step of the step.

The embodiment is not limited to this, and the determination criterions may be set by another method, using the determination region set in the operation flow of FIG. 9. For example, in another embodiment, it is also considered to generate feature amount information 1400 by setting each of the determination regions as a frequency region for extracting feature amount of each step, and detect an abnormality based on the feature amount information 1400. Also in this case, the feature amount included in the feature amount information 1400 does not include the feature amount derived from the peak based on the self-excited vibration, and the feature amount based on the strong peak of the peak intensity among the forced vibrations. As a result, it becomes possible to detect an abnormality with high accuracy.

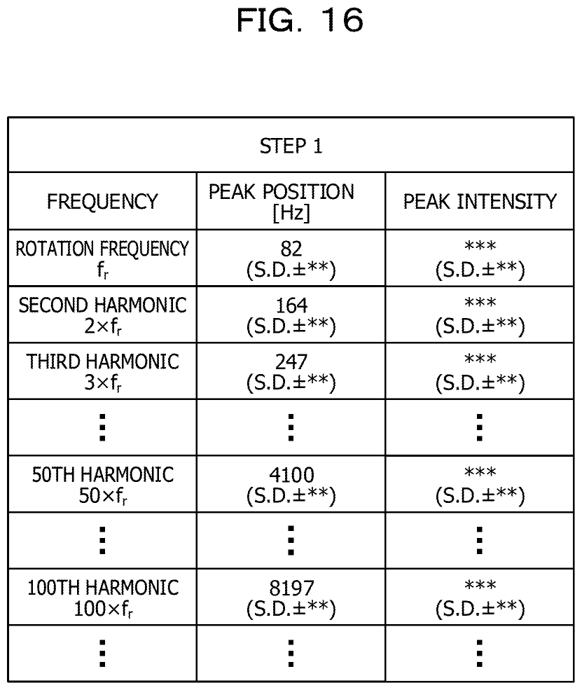

In the above-described embodiment, the case where the abnormality determination criterion information 1300 is generated for each change point and the abnormality determination criterion information 1300 includes information on the rotation frequency and the harmonic before and after the change point is illustrated as an example. However, the embodiment is not limited to this. For example, as illustrated in FIG. 16, the abnormality determination criterion information 1300 may include information on the rotation frequency and information on the harmonics of the rotation frequency generated for each step. Furthermore, the control unit 501 may manage the abnormality determination criterion information 1300 generated for each step as one piece of abnormality determination criterion information.

In the above-described embodiment, for example, in the operation flow of FIGS. 9 and 11, the control unit 501 operates as the setting unit 511, for example. Further, in the operation flow of FIG. 12, the control unit 501 operates as the generation unit 512, for example.

Although the embodiment is exemplified above, the embodiment is not limited thereto. For example, the above-described operation flow is an example, and the embodiment is not limited thereto. If possible, the operation flow may be executed by changing the order of processing and may include another processing separately, or some processing may be omitted. For example, the processing in S1502 and S1503 in FIG. 15 may be executed while changing the order. In addition, S1509 in FIG. 15 may be omitted.

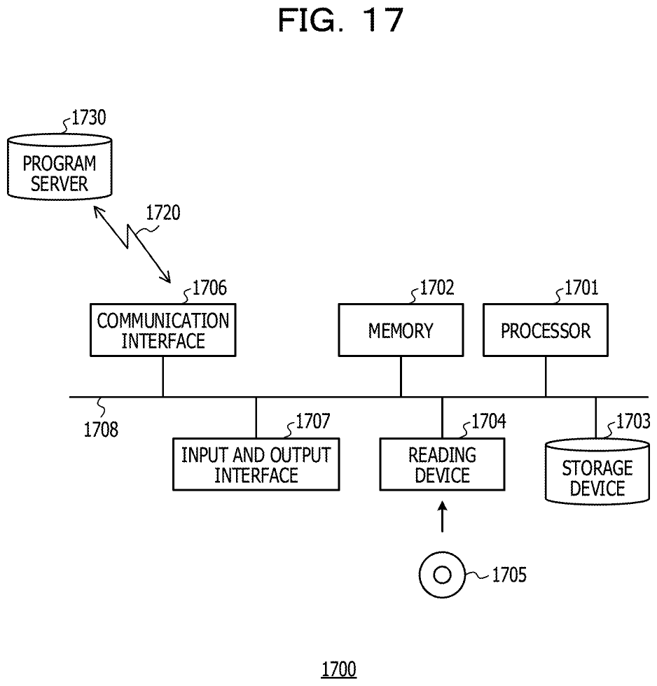

FIG. 17 is a diagram illustrating a hardware configuration of a computer 1700 for realizing the abnormality determination apparatus 103 according to the embodiment. The hardware configuration for realizing the abnormality determination apparatus 103 in FIG. 17 includes, for example, a processor 1701, a memory 1702, a storage device 1703, a reading device 1704, a communication interface 1706, and an input and output interface 1707. The processor 1701, the memory 1702, the storage device 1703, the reading device 1704, the communication interface 1706, and the input and output interface 1707 are connected to each other via a bus 1708, for example.

The processor 1701 may be, for example, a single processor, a multiprocessor, or a multicore. The processor 1701 provides a part or all of the functions of the control unit 501 described above, for example, by executing a program describing the procedure of the above-described operation flow using the memory 1702. For example, the processor 1701 may operate as the setting unit 511 and the generation unit 512, for example, by executing a program describing the procedure of the above-described operation flow using the memory 1702. The storage unit 502 described above includes, for example, a memory 1702, a storage device 1703, and a detachable storage medium 1705. The storage device 1703 of the abnormality determination apparatus 103 stores, for example, abnormality determination criterion information 1300, feature amount information 1400, and the like.

The memory 1702 is, for example, a semiconductor memory, and may include a RAM area and a ROM area. The storage device 1703 is, for example, a hard disk, a semiconductor memory such as a flash memory, or an external storage device. RAM is an abbreviation for random access memory. In addition, ROM is an abbreviation for read only memory.

The reading device 1704 accesses the detachable storage medium 1705 according to the instruction of the processor 1701. The detachable storage medium 1705 may be realized, for example, a semiconductor device (USB memory or the like), a medium (a magnetic disk or the like) to which information is input and output by magnetic action, a medium (a CD-ROM, a DVD, or the like) to which information is input and output by optical action. USB is an abbreviation for Universal Serial Bus. CD is an abbreviation for compact disc. DVD is an abbreviation for digital versatile disk.

The communication interface 1706 transmits and receives data via the network 1720 according to the instruction of the processor 1701. For example, the processor 1701 may obtain vibration data measured by the sensor 110 from the relay apparatus 102 via the communication interface 1706. The input and output interface 1707 may be, for example, an interface between an input device and an output device. The input device is, for example, a device such as a keyboard or a mouse that receives an instruction from a user. The output device is, for example, a display device such as a display and an audio device such as a speaker.

Each program according to the embodiment is provided to the abnormality determination apparatus 103, for example, in the following form.

(1) Preinstalled in the storage device 1703.

(2) Provided by the detachable storage medium 1705.

(3) Provided by the program server 1730.

The hardware configuration of the computer 1700 for realizing the abnormality determination apparatus 103 described with reference to FIG. 17 is an example, and the embodiment is not limited. For example, some or all of the functions described above may be implemented as hardware such as FPGA and SoC. FPGA is an abbreviation for field programmable gate array. SoC is an abbreviation for system-on-a-chip.

Further, in the above embodiment, an example is described in which the abnormality determination apparatus 103 is provided separately from the monitoring target apparatus 101, and the monitoring target apparatus 101 exchanges data with the abnormality determination apparatus 103 via the relay apparatus 102. However, the embodiment is not limited to this. For example, some or all of the functions of the monitoring target apparatus 101 and the abnormality determination apparatus 103 may be arranged in another device (for example, a terminal held by a user of the monitoring target apparatus 101), and may further include another device.

Several embodiments are described above. However, the embodiments are not limited to the above-described embodiments, but it is desirable to be understood as including various modifications and alternatives of the above-described embodiments. For example, it will be understood that the various embodiments may be modified and embodied without departing from the spirit and scope of the disclosure. In addition, it will be understood that various embodiments may be implemented by appropriately combining a plurality of constituent elements disclosed in the above embodiments. Furthermore, those skilled in the art will understand that various embodiments may be implemented by deleting or replacing some constituent elements from all the constituent elements illustrated in the embodiments, or by adding some constituent elements to the constituent elements illustrated in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An apparatus for determining an abnormality, the apparatus comprising:
a memory; and
a processor coupled to the memory, the processor being configured to
execute setting processing that includes setting a determination region so as to exclude range of a frequency component of which waveforms of vibrations in a step before a change and a step after a change coincide each other in a predetermined error range, in a frequency spectrum for each step, the frequency spectrum being obtained from vibration data that is obtained by detecting, by a sensor, a vibration of a monitoring target apparatus executing a plurality of steps in a predetermined order using a rotary part, and
execute generating processing that includes generating abnormality determination criterion information indicating a frequency region used to determine an abnormality of the monitoring target apparatus, in accordance with peaks of the frequency spectrum detected in the determination region.

2. The apparatus according to claim 1,
wherein the processor is further configured to
execute second generating processing that includes selecting, among the peaks of the frequency spectrum detected in the determination region, peaks from a peak having a highest intensity to a peak at which the predetermined condition is not satisfied, and generating the abnormality determination criterion information indicating the frequency region used to determine an abnormality of the monitoring target apparatus based on the selected peaks.

3. The apparatus according to claim 2,
wherein the abnormality determination criterion information includes a plurality of the frequency regions corresponding to the selected peaks, and a peak intensity corresponding to each of the plurality of frequency regions, for each step of a plurality of steps, and
wherein the processor is further configured to
execute abnormality determination processing that includes determining an abnormality of the monitoring target apparatus based on the plurality of frequency regions for each step of the plurality of steps, included in the abnormality determination criterion information, and the peak intensity corresponding to each of the plurality of frequency regions.

4. The apparatus according to claim 3,
wherein the abnormality determination processing is configured to
in a case where, after it is detected that the frequency spectrum obtained by transforming the vibration data measured by the sensor includes peaks in the plurality of frequency regions, corresponding to a first step of the plurality of steps, of the abnormality determination criterion information, a peak is not detected in at least one frequency region of the plurality of frequency regions corresponding to the first step, determine whether the frequency spectrum includes peaks in the plurality of frequency regions corresponding to a second step subsequently executed after a first step, and
output information indicating an abnormality in a case where the frequency spectrum does not include a peak in at least one frequency region of the plurality of frequency regions corresponding to the second step.

5. The apparatus according to claim 4,
wherein the abnormality determination processing is configured to
in a case where it is detected that the frequency spectrum obtained by transforming the vibration data measured by the sensor includes peaks in the plurality of frequency regions, corresponding to the first step, included in the abnormality determination criterion information, when a peak intensity included in the plurality of frequency regions corresponding to the first step is not within predetermined error range from the peak intensity corresponding to each of the plurality of frequency regions corresponding to the first step, output the information indicating an abnormality.

6. A method of determining an abnormality, the method comprising:
executing, by a processor, setting processing that includes setting a determination region so as to exclude range of a frequency component of which waveforms of vibrations in a step before a change and a step after a change coincide each other in a predetermined error range, in a frequency spectrum for each step, the frequency spectrum being obtained from vibration data that is obtained by detecting, by a sensor, a vibration of a monitoring target apparatus executing a plurality of steps in a predetermined order using a rotary part, and
executing, by the processor, generating processing that includes generating abnormality determination criterion information indicating a frequency region used to determine an abnormality of the monitoring target apparatus, in accordance with peaks of the frequency spectrum detected in the determination region.

7. The method according to claim 6, further comprising:
executing second generating processing that includes selecting, among the peaks of the frequency spectrum detected in the determination region, peaks from a peak having a highest intensity to a peak at which the predetermined condition is not satisfied, and generating the abnormality determination criterion information indicating the frequency region used to determine an abnormality of the monitoring target apparatus based on the selected peaks.

8. The method according to claim 7,
wherein the abnormality determination criterion information includes a plurality of the frequency regions corresponding to the selected peaks, and a peak intensity corresponding to each of the plurality of frequency regions, for each step of a plurality of steps, and
wherein the method further comprises:
executing abnormality determination processing that includes determining an abnormality of the monitoring target apparatus based on the plurality of frequency regions for each step of the plurality of steps, included in the abnormality determination criterion information, and the peak intensity corresponding to each of the plurality of frequency regions.

9. The method according to claim 8,
wherein the abnormality determination processing is configured to
in a case where, after it is detected that the frequency spectrum obtained by transforming the vibration data measured by the sensor includes peaks in the plurality of frequency regions, corresponding to a first step of the plurality of steps, of the abnormality determination criterion information, a peak is not detected in at least one frequency region of the plurality of frequency regions corresponding to the first step, determine whether the frequency spectrum includes peaks in the plurality of frequency regions corresponding to a second step subsequently executed after a first step, and
output information indicating an abnormality in a case where the frequency spectrum does not include a peak in at least one frequency region of the plurality of frequency regions corresponding to the second step.

10. The method according to claim 9,
wherein the abnormality determination processing is configured to
in a case where it is detected that the frequency spectrum obtained by transforming the vibration data measured by the sensor includes peaks in the plurality of frequency regions, corresponding to the first step, included in the abnormality determination criterion information, when a peak intensity included in the plurality of frequency regions corresponding to the first step is not within predetermined error range from the peak intensity corresponding to each of the plurality of frequency regions corresponding to the first step, output the information indicating an abnormality.

11. A non-transitory computer-readable storage medium for storing a program which causes a processor to perform processing for determining an abnormality, the processing comprising:
executing, by a processor, setting processing that includes setting a determination region so as to exclude range of a frequency component of which waveforms of vibrations in a step before a change and a step after a change coincide each other in a predetermined error range, in a frequency spectrum for each step, the frequency spectrum being obtained from vibration data that is obtained by detecting, by a sensor, a vibration of a monitoring target apparatus executing a plurality of steps in a predetermined order using a rotary part, and
executing, by the processor, generating processing that includes generating abnormality determination criterion information indicating a frequency region used to determine an abnormality of the monitoring target apparatus, in accordance with peaks of the frequency spectrum detected in the determination region.

12. The non-transitory computer-readable storage medium according to claim 11, further comprising:
executing second generating processing that includes selecting, among the peaks of the frequency spectrum detected in the determination region, peaks from a peak having a highest intensity to a peak at which the predetermined condition is not satisfied, and generating the abnormality determination criterion information indicating the frequency region used to determine an abnormality of the monitoring target apparatus based on the selected peaks.

13. The non-transitory computer-readable storage medium according to claim 12,
wherein the abnormality determination criterion information includes a plurality of the frequency regions corresponding to the selected peaks, and a peak intensity corresponding to each of the plurality of frequency regions, for each step of a plurality of steps, and
wherein the method further comprises:
executing abnormality determination processing that includes determining an abnormality of the monitoring target apparatus based on the plurality of frequency regions for each step of the plurality of steps, included in the abnormality determination criterion information, and the peak intensity corresponding to each of the plurality of frequency regions.

14. The non-transitory computer-readable storage medium according to claim 13,
wherein the abnormality determination processing is configured to
in a case where, after it is detected that the frequency spectrum obtained by transforming the vibration data measured by the sensor includes peaks in the plurality of frequency regions, corresponding to a first step of the plurality of steps, of the abnormality determination criterion information, a peak is not detected in at least one frequency region of the plurality of frequency regions corresponding to the first step, determine whether the frequency spectrum includes peaks in the plurality of frequency regions corresponding to a second step subsequently executed after a first step, and
output information indicating an abnormality in a case where the frequency spectrum does not include a peak in at least one frequency region of the plurality of frequency regions corresponding to the second step.

15. The non-transitory computer-readable storage medium according to claim 14,
wherein the abnormality determination processing is configured to
in a case where it is detected that the frequency spectrum obtained by transforming the vibration data measured by the sensor includes peaks in the plurality of frequency regions, corresponding to the first step, included in the abnormality determination criterion information, when a peak intensity included in the plurality of frequency regions corresponding to the first step is not within predetermined error range from the peak intensity corresponding to each of the plurality of frequency regions corresponding to the first step, output the information indicating an abnormality.
